(19) United States
(12) Patent Application Publication
(10) Pub. No.: US 2026/0184080 A1
(43) Pub. Date: Jul. 2, 2026

(54) RECORDING DEVICE

(71) Applicant: SEIKO EPSON CORPORATION, Tokyo (JP)

(72) Inventors: Katsunari KUMAGAI, OKAYA-SHI (JP); Kensuke TAMAI, SHIOJIRI-SHI (JP); Chiaki ENDO, SHIOJIRI-SHI (JP)

(21) Appl. No.: 19/428,440

(22) Filed: Dec. 22, 2025

(30) Foreign Application Priority Data
Dec. 27, 2024 (JP) 2024-232713

(51) Int. Cl. B41J 2/17; B41J 2/21; B41J 11/00; B41J 11/08

(52) U.S. Cl. CPC B41J 2/1742; B41J 2/2103; B41J 11/0065; B41J 11/08

(57) ABSTRACT

A liquid receiving section of a recording device wherein assuming that a plurality of ribs provided in the first region are a first upstream rib, a first midstream rib, and a first downstream rib from upstream to downstream of a transport path, assuming that a plurality of ribs provided in the second region positioned on both sides of the first region are a second upstream rib, a second midstream rib, and a second downstream rib from upstream to downstream, a height of the first upstream rib is equal to or higher than a height of the first midstream rib and higher than a height of the first downstream rib, and a height of the second upstream rib is equal to or higher than a height of the second midstream rib and higher than a height of the second downstream rib.

The present application is based on, and claims priority from JP Application Serial Number 2024-232713, filed December 27, 2024, the disclosure of which is hereby incorporated by reference herein in its entirety.

### BACKGROUND

### 1. Technical Field

The present disclosure relates to a recording device for recording on a medium.

### 2. Related Art

JP-A-2017-128125 discloses an inkjet printing device capable of performing borderless printing. A plurality of ink grooves are formed in a platen for supporting a sheet by a large number of ribs provided along a transport direction of sheets. Ink that was ejected toward the platen and that landed on the platen during borderless printing is captured by the ink grooves, guided to an ink absorber, and absorbed by the ink absorber.

The arrangement described in JP-A-2017-128125 has room for improvement in terms of reducing the occurrence of ink mist.

### SUMMARY

To solve the above problem, a recording device of the present disclosure includes a liquid ejection head configured to, in a transport path that transports the medium, perform recording by ejecting liquid onto a medium; a support section configured to, at a position facing the liquid ejection head, support the medium; a liquid receiving section that is a portion provided in the support section and that is configured to receive liquid ejected from the liquid ejection head; and a transport section that is positioned upstream of the support section in the transport path and that is configured to transport the medium, wherein the liquid receiving section is provided with a plurality of ribs extending along a width direction, which is a direction intersecting a medium transport direction, at intervals along the medium transport direction, the liquid receiving section includes, as a region for receiving liquid, a first region and a second region, which are positioned on both sides with respect to the first region in the width direction, the second region is a region that receives liquid ejected at a position deviated from an end portion of the medium in the width direction, assuming that a plurality of ribs provided in the first region are first ribs and a plurality of ribs provided in the second region are second ribs, assuming that among the plurality of first ribs, a rib that is positioned most upstream in the transport path is a first upstream rib, a rib that is positioned downstream of the first upstream rib in the transport path is a first midstream rib, and a rib that is positioned downstream of the first midstream rib in the transport path is a first downstream rib, assuming that among the plurality of second ribs, a rib that is positioned most upstream in the transport path is a second upstream rib, a rib that is positioned downstream of the second upstream rib in the transport path is a second midstream rib, and a rib that is positioned downstream of the second midstream rib in the transport path is a second downstream rib, a height of the first upstream rib is equal to or higher than a height of the first midstream rib and higher than a height of the first downstream rib, and a height of the second upstream rib is equal to or higher than a height of the second midstream rib and higher than a height of the second downstream rib.

### BRIEF DESCRIPTION OF THE DRAWINGS

FIG. 1 is an external perspective view of a printer.

FIG. 2 is an external perspective view of the printer with a document cover opened.

FIG. 3 is an external perspective view of the printer with a scanner section opened.

FIG. 4 is an external perspective view of the printer with a scanner section opened, in which an operation panel is omitted.

FIG. 5 is a perspective view of a recording unit with a housing removed.

FIG. 6 is a diagram illustrating a medium transport path in the recording unit.

FIG. 7 is a perspective view of a liquid receiving section provided in a support member.

FIG. 8A is a plan view of the liquid receiving section provided in the support member.

FIG. 8B is a plan view of the liquid receiving section provided in the support member, in which ribs are omitted.

FIG. 9 is a cross-sectional view taken along line A-A in FIG. 7.

FIG. 10 is a plan view of a head surface of a recording head.

### DESCRIPTION OF EMBODIMENTS

Hereinafter, the present disclosure will be generally described.

A recording device according to a first aspect includes a liquid ejection head configured to, in a transport path that transports the medium, perform recording by ejecting liquid onto a medium; a support section configured to, at a position facing the liquid ejection head, support the medium; a liquid receiving section that is a portion provided in the support section and that is configured to receive liquid ejected from the liquid ejection head; and a transport section that is positioned upstream of the support section in the transport path and that is configured to transport the medium, wherein the liquid receiving section is provided with a plurality of ribs extending along a width direction, which is a direction intersecting a medium transport direction, at intervals along the medium transport direction, the liquid receiving section includes, as a region for receiving liquid, a first region and a second region, which are positioned on both sides with respect to the first region in the width direction, the second region is a region that receives liquid ejected at a position deviated from an end portion of the medium in the width direction, assuming that a plurality of ribs provided in the first region are first ribs and a plurality of ribs provided in the second region are second ribs, assuming that among the plurality of first ribs, a rib that is positioned most upstream in the transport path is a first upstream rib, a rib that is positioned downstream of the first upstream rib in the transport path is a first midstream rib, and a rib that is positioned downstream of the first midstream rib in the transport path is a first downstream rib, assuming that among the plurality of second ribs, a rib that is positioned most upstream in the transport path is a second upstream rib, a rib that is positioned downstream of the second upstream rib in the transport path is a second midstream rib, and a rib that is positioned downstream of the second midstream rib in the transport path is a second downstream rib, a height of the first upstream rib is equal to or higher than a height of the first midstream rib and higher than a height of the first downstream rib, and a height of the second upstream rib is equal to or higher than a height of the second midstream rib and higher than a height of the second downstream rib.

The further a leading edge of the medium is from the transport section to the downstream side of the transport path, the smaller the influence of the restraint by the transport section becomes, and the more easily the leading edge of the medium hangs downward. Therefore, there is a concern that the leading edge of the medium will contact the rib and the medium will be contaminated, or there is a concern that the leading edge of the medium will be caught by the rib and a jam occurs. The amount of liquid absorbed by the trailing edge of the medium increases as transport progresses, and a trailing edge of the medium is likely to hang downward. Therefore, there is a concern that the trailing edge of the medium will contact the rib and the medium will be contaminated. As described above, it is desirable that the height of the rib positioned downstream of the transport path among the plurality of ribs is as low as possible in order to avoid contact with the leading edge or the trailing edge of the medium. However, when the height of the rib is uniformly reduced, a gap between the liquid ejection head and the rib increases, and thus, mist is likely to be generated.

According to the present aspect, the height of the first upstream rib is equal to or higher than the height of the first midstream rib and is higher than the height of the first downstream rib. The height of the first upstream rib being equal to or higher than the height of the first midstream rib includes the height of the first upstream rib being the same as the height of the first midstream rib and the height of the first upstream rib being higher than the height of the first midstream rib.

By this, it is possible to suppress the generation of mist due to the increase in the gap between the first upstream rib and the liquid ejection head while suppressing the contact of the leading edge or the trailing edge of the medium with the rib downstream of the first upstream rib. The height of the second upstream rib is equal to or higher than the height of the second midstream rib and is higher than the height of the second downstream rib. The height of the second upstream rib being equal to or higher than the height of the second midstream rib includes the height of the second upstream rib being the same as the height of the second midstream rib and the height of the second upstream rib being higher than the height of the second midstream rib. By this, it is possible to suppress the generation of mist due to the increase in the gap between the second upstream rib and the liquid ejection head while suppressing the contact of the leading edge or the trailing edge of the medium with the rib downstream of the second upstream rib.

The recording device of a second aspect is an aspect according to the first aspect, wherein the height of the second upstream rib is higher than the height of the second midstream rib and the height of the second midstream rib is higher than the height of the second downstream rib.

According to the present aspect, the height of the second upstream rib is higher than the height of the second midstream rib, and the height of the second midstream rib is higher than the height of the second downstream rib. By this, it is possible to suppress the generation of mist due to the increase in the gap between the second upstream rib and the liquid ejection head while suppressing the contact of the leading edge or the trailing edge of the medium with the second midstream rib or the second downstream rib.

The recording device of a third aspect is an aspect according to the first aspect, wherein the height of the first upstream rib and the height of the first midstream rib are aligned.

According to the present aspect, the height of the first upstream rib and the height of the first midstream rib are aligned. By this, it is possible to suppress the generation of mist due to the increase in the gap between the first upstream rib and the liquid ejection head and the gap between the first midstream rib and the liquid ejection head while suppressing the contact of the leading edge or the trailing edge of the medium with the first downstream rib. Note that the present aspect is not limited to the first aspect and may be dependent on the second aspect.

The recording device of a fourth aspect is an aspect according to the first aspect, wherein the height of the second upstream rib is equal to or less than the height of the first downstream rib.

Since the medium curls so as to protrude upward by absorbing liquid, the edge portion in the width direction is likely to hang downward. According to the present aspect, the height of the second upstream rib provided in the second region positioned on both sides of the first region in the width direction is equal to or less than the height of the first downstream rib. By this, it is possible to suppress the contact of both edge portions of the medium in the width direction with the rib provided in the second region. Note that the present aspect is not limited to the first aspect and may be dependent on the second or third aspect.

The recording device of a fifth aspect is an aspect according to the first aspect, wherein the support section has, as portions that support medium, a plurality of first support sections disposed at intervals along the width direction, a plurality of second support sections that are positioned downstream of the first support sections in the transport path and that are disposed at intervals along the width direction, a plurality of third support sections that are positioned downstream of the second support sections in the transport path and that are disposed at intervals along the width direction, and a plurality of fourth support sections that are positioned downstream of the third support sections in the transport path and that are disposed at intervals along the width direction, the second support sections and the third support sections are positioned in the first region, at least some of a plurality of the first upstream ribs are positioned between the first support sections and the second support sections in the transport path, at least some of a plurality of the first midstream ribs are positioned between the second support sections and the third support sections in the transport path, at least some of a plurality of the first downstream ribs are positioned between the third support sections and the fourth support sections in the transport path, at least one first upstream rib or one first midstream rib is disposed between two second support sections that are adjacent to each other in the width direction, and at least one first midstream rib or one first downstream rib is disposed between two third support sections that are adjacent to each other in the width direction.

According to the present aspect, the medium can be supported in the first region by the second support sections and the third support sections, and the medium can be prevented from hanging down. At least one first upstream rib or one first midstream rib is disposed between the two second support sections that are adjacent to each other in the width direction. By this, the liquid can be received between the two second support sections adjacent to each other. At least one first midstream rib or one first downstream rib is disposed between two third support sections that are adjacent to each other in the width direction. By this, liquid can be received between the two third support sections adjacent to each other. Note that the present aspect is not limited to the first aspect and may be according to any of the second to fourth aspects.

The recording device of a sixth aspect is an aspect according to the first aspect, wherein a length of the first rib in the width direction is longer than a length of the second rib.

According to the present aspect, in the configuration in which the length of the first rib in the width direction is longer than the length of the second rib, the operational effect of the fourth aspect described above is obtained. Note that the present aspect is not limited to the first aspect and may be dependent on any of the second to fifth aspects.

The recording device of a seventh aspect is an aspect according to the first aspect, wherein a height position of the base end section of the first rib and the base end section of the second rib are aligned.

According to the present aspect, the height positions of the base end section of the first rib and the base end section of the second rib are aligned. By this, the height positions of the bottom portion of the groove formed between two adjacent first ribs and the bottom portion of the groove formed between two adjacent second ribs are aligned. By this, the dimension of the support section in the height direction can be suppressed as compared with a configuration in which the height positions of the base end section of the first rib and the base end section of the second rib are not aligned. Note that this aspect is not limited to the first aspect above, and may be according to any of the second to sixth aspects above.

The recording device of an eighth aspect is an aspect according to any one of the first aspect to the seventh aspect, wherein the liquid ejection head has a plurality of nozzles configured to eject liquid, the plurality of nozzles include, a first nozzle configured to eject a liquid of a first color, a second nozzle is a nozzle that is configured to eject a liquid of a second color, which is darker than the first color, and that is positioned upstream of the first nozzle in the transport path, and a third nozzle is a nozzle that is configured to eject a liquid of a third color, which is darker than the second color, and that is positioned upstream of the second nozzle in the transport path, at least some of the plurality of third nozzles are configured to face the first upstream rib and the second upstream rib, at least some of the plurality of second nozzles are configured to face the first midstream rib and the second midstream rib, and at least some of the plurality of first nozzles are configured to face the first downstream rib and the second downstream rib.

The darker the color of the liquid, the more noticeable the mist is when it is generated and adheres. According to the present aspect, the nozzles that ejects liquid of a deeper color faces the rib having a larger height. Specifically, at least some of the plurality of third nozzles face the first upstream rib that is the highest among the first ribs, and face the second upstream rib that is the highest among the second ribs. The third nozzles eject the liquid of the third color, which is the deepest color among the first, second, and third colors. By this, when the liquid of the third color, which is the deepest color, is ejected, it is possible to suppress the generation of mist and to make a portion to which the mist is attached inconspicuous. The same applies to the case of the liquid of the second color, it is possible to suppress the generation of mist compared to the first color, and to make a portion to which the mist is attached inconspicuous. Note that the second color being deeper than the first color means at least one of the brightness of the second color being lower than the brightness of the first color and the saturation of the second color being lower than the saturation of the first color. The same applies to the relationship between the second color and the third color.

The recording device of a ninth aspect is an aspect according to the eighth aspect, wherein the third color is cyan, the second color is magenta, and the first color is yellow.

According to the present aspect, in the configuration in which the third color is cyan, the second color is magenta, and the first color is yellow, the operational effect of the eighth aspect described above is obtained.

A recording device according to a tenth aspect includes a liquid ejection head configured to, in a transport path that transports the medium, perform recording by ejecting liquid onto a medium; a support section configured to, at a position facing the liquid ejection head, support the medium; a liquid receiving section that is a portion provided in the support section and that is configured to receive liquid ejected from the liquid ejection head; and a transport section that is positioned upstream of the support section in the transport path and that is configured to transport the medium, wherein the liquid receiving section is provided with a plurality of ribs extending along a width direction, which is a direction intersecting a medium transport direction, at intervals along the medium transport direction, the liquid receiving section includes, as regions for receiving liquid, an upstream liquid receiving region and a downstream liquid receiving region, which is positioned in the transport path downstream with respect to the upstream liquid receiving region, and assuming that the rib provided in the upstream liquid receiving region is an upstream rib and the rib provided in the downstream liquid receiving region is a downstream rib, a height of the upstream rib is higher than a height of the downstream rib.

The further a leading edge of the medium is from the transport section to the downstream side of the transport path, the smaller the influence of the restraint by the transport section becomes, and the more easily the leading edge of the medium hangs downward. Therefore, there is a concern that the leading edge of the medium will contact the rib and the medium will be contaminated, or there is a concern that the leading edge of the medium will be caught by the rib and a jam occurs. The amount of liquid absorbed by the trailing edge of the medium increases as transport progresses, and a trailing edge of the medium is likely to hang downward. Therefore, there is a concern that the trailing edge of the medium will contact the rib and the medium will be contaminated. As described above, it is desirable that the height of the rib positioned downstream of the transport path among the plurality of ribs is as low as possible in order to avoid contact with the leading edge or the trailing edge of the medium. However, when the height of the rib is uniformly reduced, a gap between the liquid ejection head and the rib increases, and thus, mist is likely to be generated.

In view of the above, in the present aspect, the height of the upstream rib is higher than the height of the downstream rib. Accordingly, it is possible to suppress the generation of mist due to the increase in the gap between the upstream rib and the liquid ejection head while suppressing contact of the leading edge or the trailing edge of the medium with the downstream rib. Note that in the present specification, the height of the rib may be rephrased as the amount of protrusion of the rib toward the liquid ejection head. The higher the height of the rib, the smaller the gap between the rib and the liquid ejection head, and conversely, the lower the height of the rib, the larger the gap between the rib and the liquid ejection head.

The recording device of an eleventh aspect is an aspect according to the tenth aspect, wherein the liquid receiving section receives the liquid at a position inside both end portions of the medium in the width direction.

According to the present aspect, in the configuration in which the liquid receiving section receives the liquid on the inner side of both edge portions of the medium in the width direction, the operational effect of the first aspect described above is obtained.

The recording device of a twelfth aspect is an aspect according to the tenth aspect, wherein the liquid receiving section receives the liquid at a position outside both end portions of the medium in the width direction.

According to the present aspect, in the configuration in which the liquid receiving section receives the liquid on the outer side of both edge portions of the medium in the width direction, the operational effect of the tenth aspect described above is obtained. Note that the present aspect is not limited to the tenth aspect and may be depended on the eleventh aspect.

Hereinafter, the present disclosure will be described in detail. Hereinafter, an inkjet printer 1 that performs recording by ejecting ink onto a medium represented by a recording paper sheet will be described as an example of a recording device. Hereinafter, the inkjet printer 1 will be referred to simply as the printer 1. Note that in the following description, the term "liquid" means ink in the present embodiment, but the liquid is not limited to ink. Examples of liquid include, in addition to ink, a pre-processing liquid that performs a pre-process on the medium, a post-processing liquid that performs a post-process on the medium, and the like.

An X-Y-Z coordinate system illustrated in each drawing is an orthogonal coordinate system, and in each of an X-axis, a Y-axis, and a Z-axis, a direction indicated by an arrow is a +direction, and an opposite direction is a -direction. The Y-axis direction is a direction along a transport direction of the medium at the time of recording, and is a device depth direction. Hereinafter, when simply referred to as the transport direction, it means the +Y direction. In the present embodiment, among the side surfaces constituting the periphery of the printer 1, the side surface in the +Y direction is the front surface, and the side surface in the -Y direction is the back surface. An X-axis direction is a device width direction and, as viewed from an operator of the printer 1, a +X direction is to a left side and a -X direction is to a right side. The X-axis direction is a width direction that is a direction intersecting the transport direction. Hereinafter, the X-axis direction may be simply referred to as the width direction. A Z-axis direction is a vertical direction, that is, a device height direction, a +Z direction is an upward direction, and a -Z direction is a downward direction.

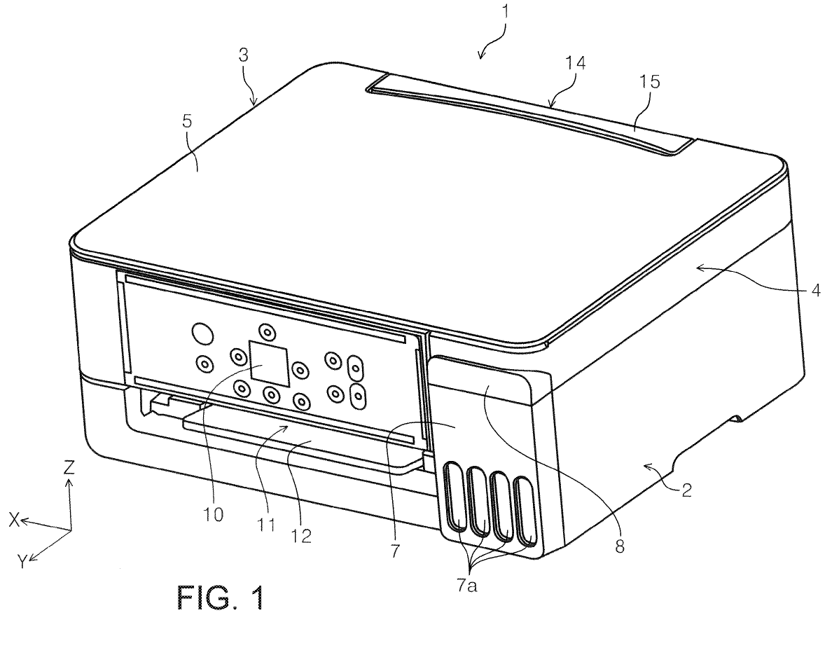

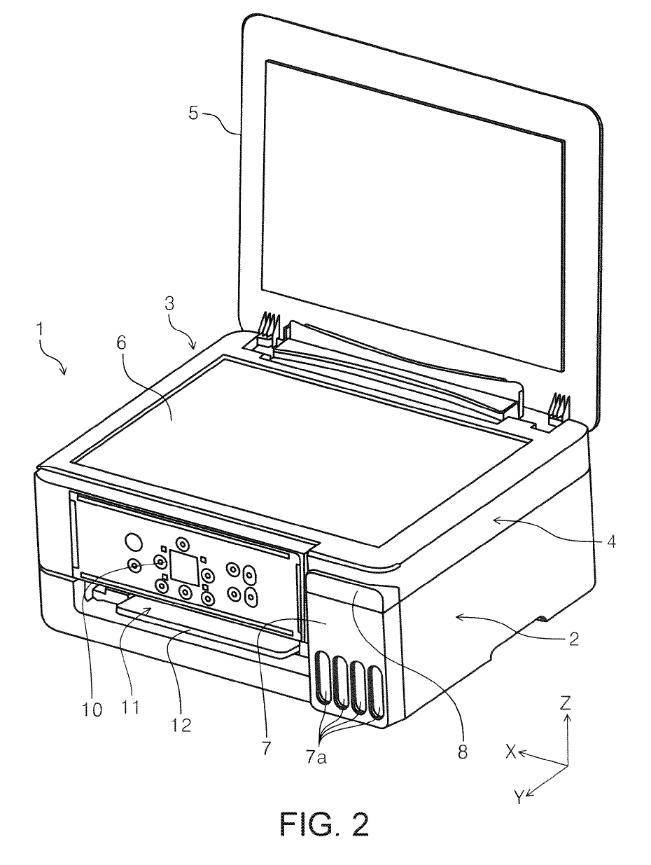

As illustrated in FIG. 1, the printer 1 is configured as a multifunction machine including a recording unit 2 and a scanner section 3 disposed on the recording unit 2. The scanner section 3, which is an example of an image reading device that reads an image of a document, includes a reading unit 4 and a document cover 5 provided on the reading unit 4. The document cover 5 is provided so as to be pivotable with respect to the reading unit 4, and when the document cover 5 is opened, a document table 6 constituting the reading unit 4 is exposed as illustrated in FIG. 2. The document table 6 is formed of, for example, a glass plate. A reading unit (not illustrated) is provided below the document table 6.

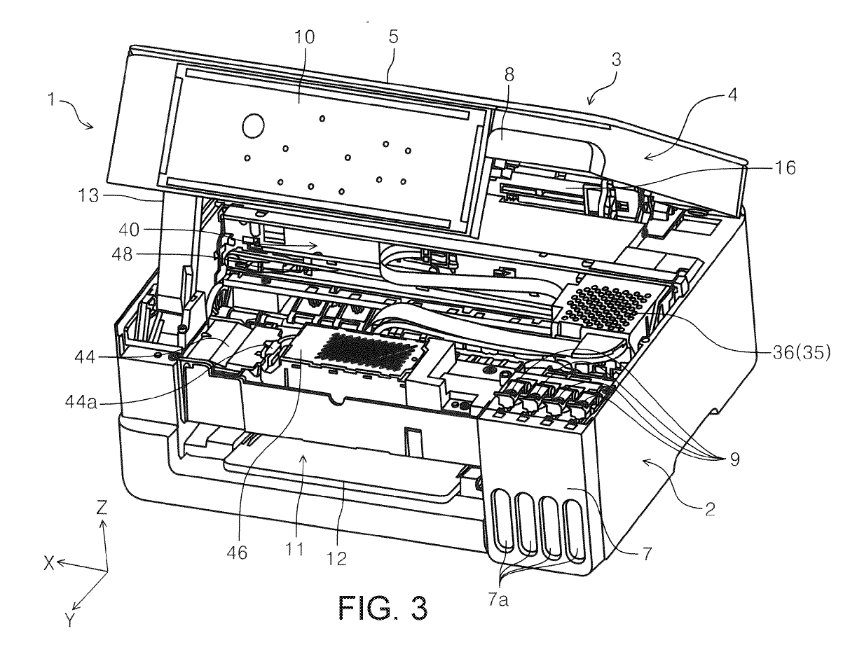

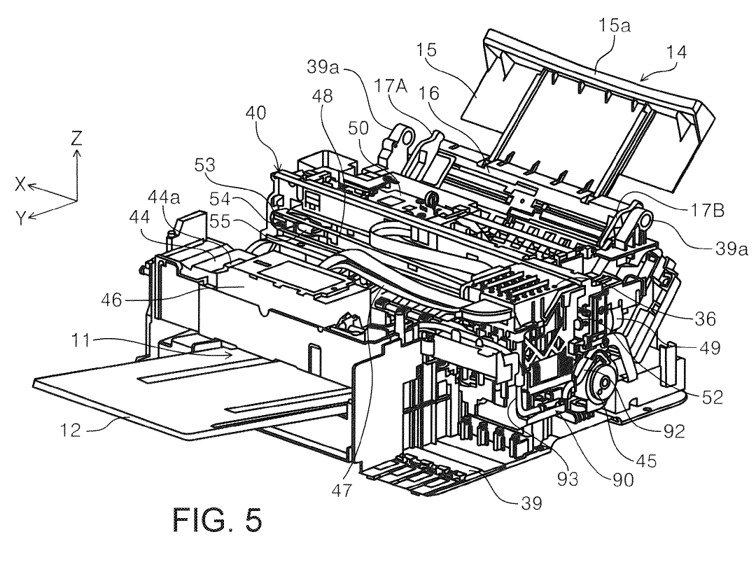

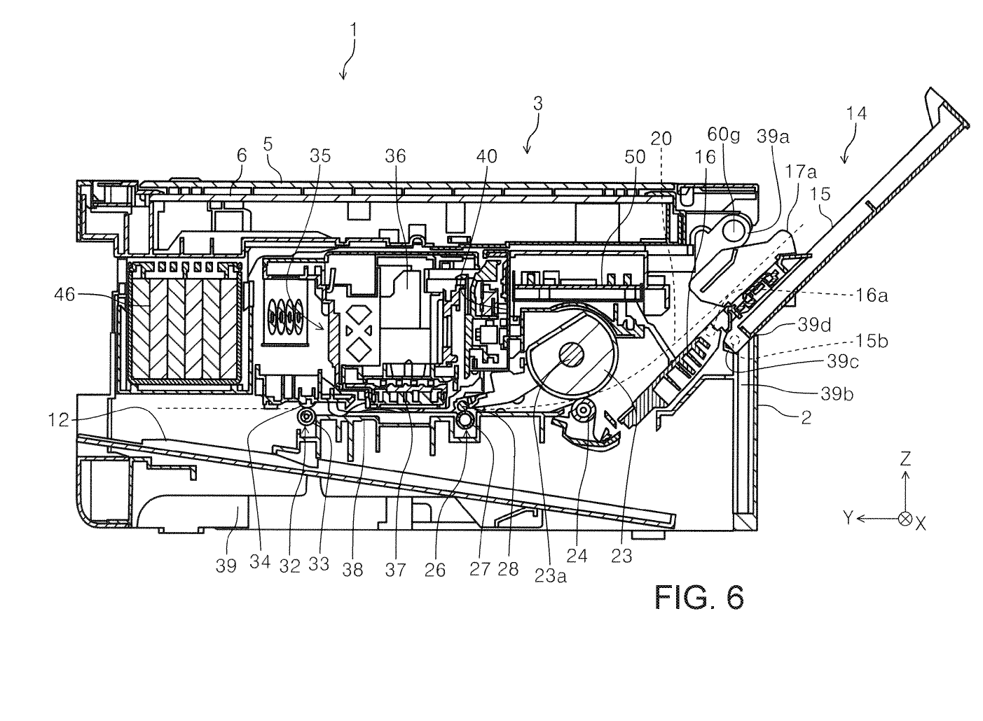

The scanner section 3 is pivotably connected to the recording unit 2 via a pivot shaft 60g (see FIG. 6), and can take a closed state as illustrated in FIG. 1 and an open state as illustrated in FIG. 3 by pivoting. The pivot shaft 60g is supported by a bearing section 39a (see FIG. 5 and FIG. 6) of a base frame 39 constituting a base body of the recording unit 2. In FIG. 3, reference symbol 13 denotes a support arm, and the support arm 13 holds the scanner section 3 in an open state. When the scanner section 3 is opened, the inside of the recording unit 2 is exposed.

In FIG. 1, an operation panel 10 is provided on the front surface side of the scanner section 3. The operation panel 10 is tiltable, and can take a state in which a panel surface is along the vertical direction as illustrated in FIG. 1 and a state in which the panel surface faces upward (not illustrated). A discharge port 11 is formed on the front surface side of the recording unit 2. A medium receiving tray 12 is provided on the discharge port 11. The medium receiving tray 12 is configured to be switchable with respect to the recording unit 2 between a housed state illustrated in FIG. 1 and a pulled-out state illustrated in FIG. 5.

An ink accommodation section 7 that accommodates ink, which is an example of a liquid, is provided on the front surface side of the recording unit 2. The ink accommodation section 7 can accommodate a plurality of colors of ink, for example, yellow, magenta, cyan, and black inks. A remaining amount viewing windows 7a for viewing the remaining amount of ink are provided on the front surface side of the ink accommodation section 7. A cover 8 is provided on the upper portion of the ink accommodation section 7. The cover 8 is provided integrally with the scanner section 3, and when the scanner section 3 is opened, the upper portion of the ink accommodation section 7 is exposed as illustrated in FIG. 3. In FIG. 3, reference symbol 9 denotes cap levers. The cap levers 9 are openable and closable, and ink inlets (not illustrated) can be exposed by opening the cap levers 9. Ink can be replenished from the ink inlets.

As illustrated in FIG. 5 and FIG. 6, a medium support section 14 that supports, in an inclined posture, the medium before being fed is provided on the back surface side of the recording unit 2. The medium support section 14 includes a support section 15 and a swing support section 16. The swing support section 16 is swingable about a swing shaft 16a (see FIG. 6), and swings by receiving power of a motor (not illustrated) to bring the supported medium is in contact with a feed roller 23.

As illustrated in FIG. 5, the swing support section 16 is provided with edge guides 17A and 17B for guiding the edges of the medium in the width direction. The edge guides 17A and 17B are provided so as to be close to or separated from each other along the width direction of the medium by a rack and pinion mechanism (not illustrated).

The support section 15 can take an expanded state illustrated in FIG. 5 and FIG. 6 and a stored state illustrated in FIG. 1. The support section 15 takes an inclined posture in the expanded state illustrated in FIG. 5 and FIG. 6. The support section 15 takes a vertical posture in the stored state illustrated in FIG. 1, and is stored on the back surface side of the base frame 39. As illustrated in FIG. 6, a guide section 39b extending along the vertical direction is formed on the back surface side of the base frame 39. A swing shaft 15b is formed in the support section 15, and the swing shaft 15b is provided to be movable along the vertical direction in the guide section 39b.

In the stored state of the support section 15, the swing shaft 15b is positioned on a lower end portion of the guide section 39b. When a user pulls up the support section 15 from this state to set the support section 15 in the inclined posture, the swing shaft 15b enters a holding section 39c provided on the upper portion of the guide section 39b. The back surface side of the support section 15 contacts against a contact section 39d of the base frame 39, and the inclined posture is maintained.

As illustrated in FIG. 5, a curved support section 15a is formed on the upper portion of the support section 15. The medium supported by the support section 15 is formed with a curve that protrudes downward along the width direction by the curved support section 15a, by this, the upper edge portion of the medium is suppressed from hanging down rearward.

Hereinafter, a transport path 20 of the medium in the recording unit 2 will be described with reference to FIG. 6. Hereinafter, a direction in which the medium is transported may be referred to as "downstream", and an opposite direction of it may be referred to as "upstream". In FIG. 6, the transport path 20 of the medium is illustrated by dashed line. In the printer 1, the medium is transported through the transport path 20.

The above described medium support section 14 is provided on the most upstream side of the transport path 20. The medium supported by the medium support section 14 is separated by being nipped by a feed roller 23 driven by a motor (not illustrated) and a separation roller 24 to which a rotation resistance is applied. The medium is sent toward a transport roller pair 26 as a "transport section". Note that reference symbol 23a is a rotation shaft of the feed roller 23.

The transport roller pair 26 includes a transport drive roller 27 driven by a transport motor (not illustrated) and a transport driven roller 28 that nips the medium with the transport drive roller 27. The transport driven roller 28 is rotatably supported by a roller support member. In the present embodiment, the transport drive roller 27 is a shaft body extending in the width direction. In the present embodiment, a plurality of the transport driven rollers 28 are provided at appropriate intervals along the width direction with respect to the transport drive roller 27.

The roller support member is swingably attached to the main frame 40 via a swing shaft (not illustrated), and the transport driven roller 28 advances and retracts with respect to the transport drive roller 27 by swinging. The roller support member is pressed in a direction in which the transport driven roller 28 advances with respect to the transport drive roller 27 by a pressing member (not illustrated), for example, a torsion spring or a tension spring.

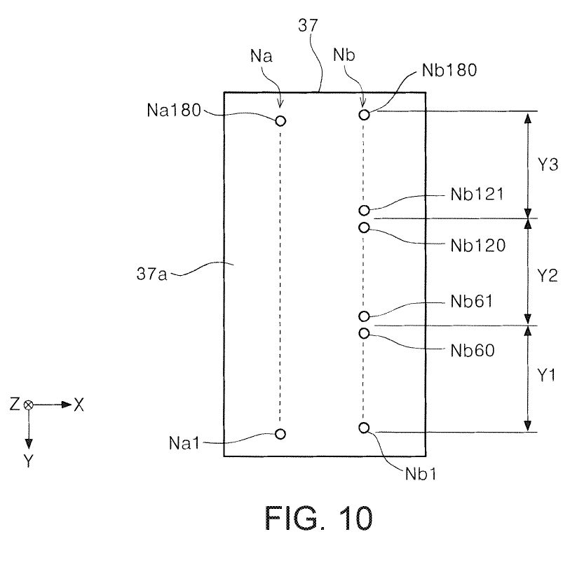

A recording section 35 includes a carriage 36 and a recording head 37, which is an example of a liquid ejection head. The carriage 36 is supported by the main frame 40 and guided in the width direction. The carriage 36 reciprocates in the width direction by receiving power of a carriage motor 49 (see FIG. 5). The recording head 37 is provided on the lower portion of the carriage 36. The recording head 37 is provided with a plurality of nozzles capable of ejecting ink in the -Z direction (see FIG. 10).

Here, the nozzle arrangement in the recording head 37 will be described with reference to FIG. 10. The plurality of nozzles for ejecting ink are provided on the lower surface of the recording head 37, that is, a head surface 37a. The nozzles Na1,..., Na180 are arranged at intervals along the Y-axis direction to form a nozzle array Na. The nozzles Nb1,..., Nb180 are arranged at intervals along the Y-axis direction to form a nozzle array Nb. The nozzle array Na and the nozzle array Nb are arranged with a predetermined interval in the width direction. The nozzle array Nb is disposed slightly upstream of the nozzle array Na. Note that it is needless to say that such this nozzle arrangement is an example, and the nozzle arrangement is not limited to this.

In the present embodiment, the nozzle array Na ejects black ink, for example. In the present embodiment, the nozzle array Nb ejects color ink, for example. In the nozzle array Nb, the nozzles Nb1 to Nb60 eject yellow ink, for example. A region indicated by reference symbol Y1 is a placement region of the nozzles Nb1 to Nb60. In the nozzle array Nb, the nozzles Nb61 to Nb120 eject magenta ink, for example. A region indicated by reference symbol Y2 is a placement region of the nozzles Nb61 to Nb120. In the nozzle array Nb, the nozzles Nb121 to Nb180 eject cyan ink as an example. A region indicated by reference symbol Y3 is a placement region of the nozzles Nb121 to Nb180. Yellow is an example of a first color, and the nozzles Nb1 to Nb60 are an examples of first nozzles. Magenta is an example of a second color that is a color darker than the first color, and the nozzles Nb61 to Nb120 are an example of second nozzles. Cyan is an example of a third color that is a color darker than the second color, and the nozzles Nb121 to Nb180 are an example of third nozzles.

The ink accommodation section 7 (see FIG. 1 to FIG. 4) accommodating the ink of each color and the recording head 37 are connected by ink tubes 47 (see FIG. 5), and the ink is supplied from the ink accommodation section 7 by the ink tubes 47. Note that in the printer 1 according to the present embodiment, the ink accommodation section 7 is independent of the carriage 36, but the ink accommodation section 7 may be provided in the carriage 36. The recording section 35 according to the present embodiment has a configuration in which the recording head 37 ejects ink while moving in the width direction, that is, is a serial type. The recording section 35 is not limited to this, and may have a configuration in which ink ejection nozzles are disposed so as to cover the entire region in the width direction and recording can be performed without movement in the width direction, that is, may be a line head.

Next, returning to FIG. 6, a support member 38, which is an example of a support section that supports the medium, is provided at a position that can face the recording head 37. The support member 38 restricts the distance between the medium and the recording head 37. The recording head 37 ejects ink onto the medium supported by the support member 38, and executes recording on the recording surface of the medium. The medium on which recording has been performed is sent to a discharge roller pair 32 provided downstream of the recording head 37 in the transport path 20.

The discharge roller pair 32 includes a discharge drive roller 33 that is driven by the transport motor (not illustrated) and a discharge driven roller 34 that nips the medium with the discharge drive roller 33. In the present embodiment, a plurality of discharge roller pairs 32 are provided at appropriate intervals along the width direction. In the present embodiment, the discharge driven roller 34 is a toothed roller having teeth on the outer periphery thereof. The discharge driven roller 34 is capable of advancing and retracting with respect to the discharge drive roller 33, and nips the medium between the discharge drive roller 33 and the discharge driven roller 34 by using a rod spring as a rotation shaft. By the discharge roller pair 32, the medium on which the recording was performed is discharged toward the medium receiving tray 12. The above is the configuration of the transport path 20.

Note that, as illustrated in FIG. 5, a maintenance section 90 is provided at an end portion in the -X direction in the reciprocating region of the carriage 36. The maintenance section 90 is provided with a cap (not illustrated) capable of sealing the ink ejection surface of the recording head 37. As illustrated in FIG. 5, a suction pump 45 is provided at a position adjacent to the maintenance section 90, and the suction pump 45 and a cap (not illustrated) are connected by a tube 92. By this, when the suction pump 45 is operated, a negative pressure is supplied into the cap (not illustrated), and waste ink is sucked from the cap (not illustrated).

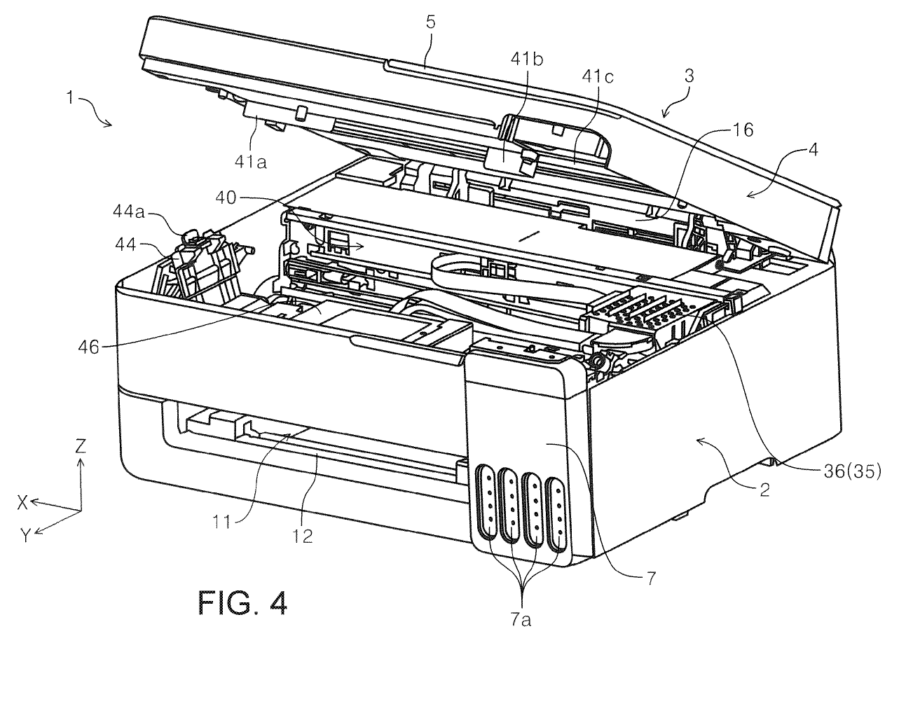

The waste ink sucked by the suction pump 45 is sent to a waste liquid container 46 through a tube 93 and collected. The suction pump 45 is driven by the transport motor (not illustrated). Assuming the rotation direction of the transport motor when the medium is transported downstream is a forward rotation direction, the suction pump 45 operates only when the transport motor rotates in a reverse rotation direction. The waste liquid container 46 is provided in an upper portion on the front side of the device. The waste liquid container 46 is attachably and detachably provided. The waste liquid container 46 is held in an attached state by a holding member 44 that can be opened and closed. The holding member 44 can be opened as illustrated in FIG. 4 from the closed state illustrated in FIG. 3 and FIG. 5 by operating an attachment and detachment operation section 44a. When the holding member 44 is opened, the waste liquid container 46 can be attached and detached.

Note that the cap levers 9 illustrated in FIG. 3 and the attachment and detachment operation section 44a are portions operated by the user, but they are close to the reciprocating region of the recording head 37, and thus, ink mist is likely to adhere to them, which may contaminate the fingers of the user. For this reason, as illustrated in FIG. 4, wall sections 41a, 41b, and 41c are provided in the lower portion of the scanner section 3. When the scanner section 3 is closed, the wall section 41a is positioned at a position where the attachment and detachment operation section 44a and the reciprocating region of the recording head 37 are separated from each other, by this, the adhesion of ink mist to the attachment and detachment operation section 44a is suppressed. When the scanner section 3 is closed, the walls 41b and 41c are positioned at positions that separate the cap levers 9 and the reciprocating region of the recording head 37, by this, the adhesion of ink mist to the cap levers 9 is suppressed.

Next, in FIG. 5 and FIG. 6, reference symbol 40 is the main frame constituting the base body of the recording unit 2. The main frame 40 is positioned between the medium support section 14 and the recording section 35. A main board 50 is provided in a horizontal state on the back surface side of the main frame 40. The main board 50 constitutes a control section that controls the entire printer 1, and various electronic components and connectors are mounted thereon.

As illustrated in FIG. 5, the carriage motor 49 is provided on the back surface side of the main frame 40. A carriage belt 48 for pulling the carriage 36 is provided on the front surface side of the main frame 40. A drive pulley 52 is provided at an end portion of the main frame 40 in the -X direction. A driven pulley 53 is provided at an end portion of the main frame 40 in the + X direction. The carriage belt 48 is wound around the drive pulley 52 and the driven pulley 53. The drive pulley 52 is provided on a rotation shaft of the carriage motor 49. The driven pulley 53 is supported by a holder 54. The holder 54 is provided to be displaceable in the X-axis direction in the main frame 40, and is pressed in the +X direction by a compression coil spring 55, which is an example of a pressing member. By this, tension along the X-axis direction is applied to the carriage belt 48.

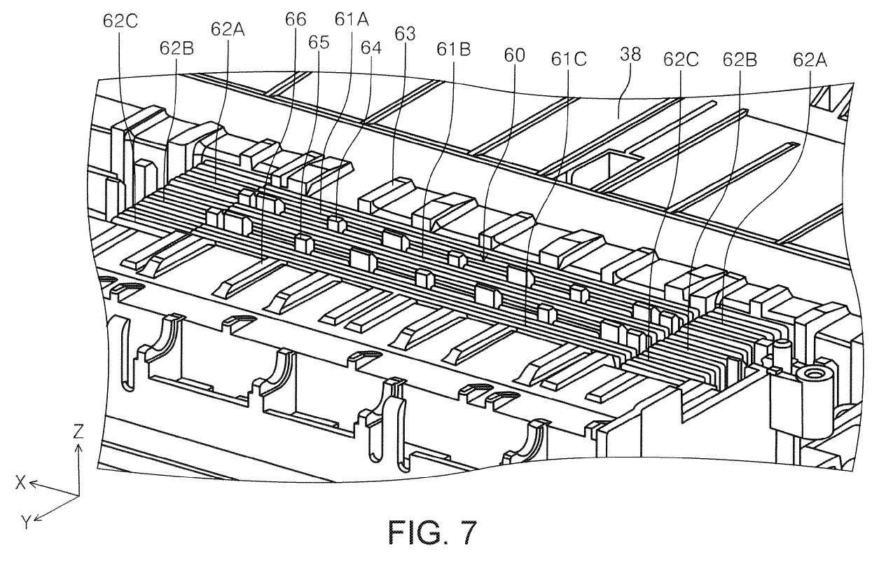

Next, a liquid receiving section 60 provided in the support member 38 will be described with reference to FIG. 7 and the subsequent drawings. The liquid receiving section 60 is a portion for performing borderless printing on four sides of the medium, and is a portion used as a discarding region when discarding ink to a region outside the leading edge, the trailing edge, and both side edges of the medium. The liquid receiving section 60 is provided with a plurality of ribs extending along the width direction at intervals along the transport direction. The ribs are illustrated by reference symbols 61A, 61B, 61C, 62A, 62B, and 62C in FIG. 7 and the subsequent drawings. When these ribs are not distinguished from each other, they are simply collectively referred to as ribs. The ribs indicated by the reference symbols 61A, 61B, and 61C may be collectively referred to as first ribs 61. The ribs indicated by the reference signs 62A, 62B, and 62C may be collectively referred to as second ribs 62. The plurality of ribs are provided along the transport direction, and a groove is formed between two ribs that are adjacent to each other in the transport direction. The ink ejected from the recording head 37 is captured by the ribs, falls to the bottom of the groove between two adjacent ribs, and flows in the width direction.

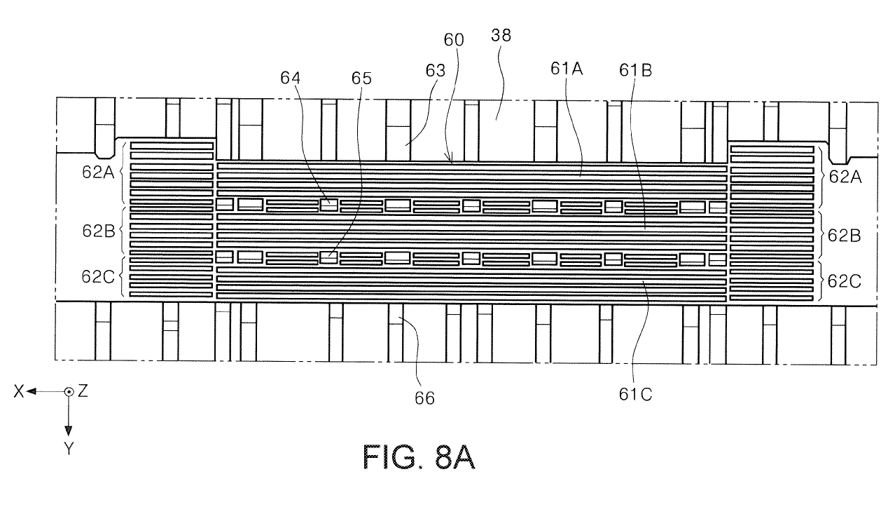

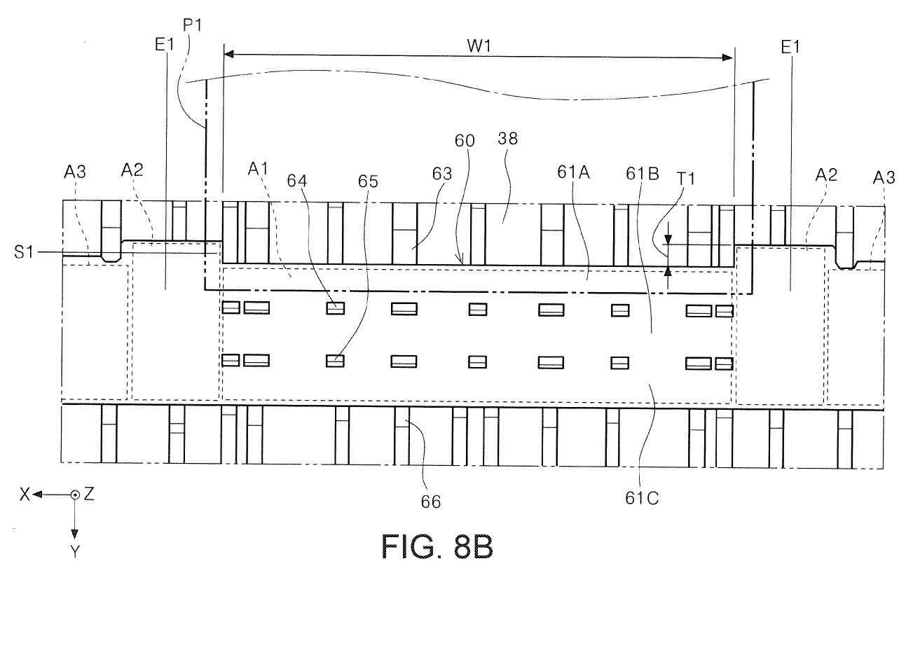

Hereinafter, it will be described in more detail. In FIG. 8B, the ribs illustrated in FIG. 8A are omitted in order to avoid complication of the diagram. The liquid receiving section 60 has, as regions for receiving liquid, that is, ink, a first region A1 and second regions A2, which are positioned on both sides of the first region A1 in the width direction. Note that a third regions A3 are provided further to the outside than the second regions A2. The second region A2 is a region that receives ink ejected to a position deviated from an edge portion, that is, a side edge of the medium in the width direction. The first region A1 is a region that receives ink that was ejected to a position deviated from the leading edge or the trailing edge of the medium.

The support member 38 includes a first support section 63, a second support section 64, a third support section 65, and a fourth support section 66 as portions that support the medium. A plurality of each type of support section is disposed at intervals along the width direction. Each support section is formed so as to protrude from the support member 38 in the +Z direction, that is, toward the recording head 37. The second support section 64 and the third support section 65 among each support section are provided in the first region A1. The first support section 63 is disposed upstream of the second region A2. The second support section 64 is positioned downstream of the first support section 63. The third support section 65 is positioned downstream of the second support section 64. The fourth support section 66 is disposed downstream of the second region A2.

The upstream edge of the first region A1 is positioned downstream of the upstream edge of the second region A2 in the transport direction. Reference symbol T1 indicates the amount of deviation in the transport direction between the upstream edge of the first region A1 and the upstream edge of the second region A2. In other words, with such a configuration, it can be said that the first support section 63 positioned in the range of the first region A1 in the width direction extends downstream from the other first support section 63.

Here, a medium P1 illustrated in FIG. 8B is L-format size medium with the short side being 89mm and the long side being 127mm, and an example is illustrated in which the short side is transported along the width direction. In FIG. 8B, the leading edge of the medium P1 is positioned between the first support section 63 and the second support section 64. In this state, the cyan ink is ejected from the nozzles Nb121 to Nb180 illustrated in FIG. 10, and thus, borderless printing is performed on the leading edge of the medium and both side edges of the medium with the cyan ink. In this case, the first support section 63 positioned in the range of the first region A1 in the width direction extends downstream from the other first support section 63, and thus, the medium is supported on the further downstream side, and it is possible to suppress the leading edge of the medium from hanging down.

Note that the position indicated by reference symbol S1 in FIG. 8B is the position of the nozzle Nb180 in the transport direction among the plurality of nozzles described with reference to FIG. 10. Position E1 is a position of the medium side edge when the medium of KGL-format size with the short side at 102mm and the long side at 152mm is transported with the short side along the width direction. In this way, in the present embodiment, when L-format size medium or KGL-format size medium is transported, the medium side edge passes through the second region A2. Note that a liquid absorbing material (not illustrated) is provided in the third region A3. The ink discarded to the first region A1 and the second region A2 falls to the bottom of the groove between the two adjacent ribs, flows in the width direction, and is absorbed by the liquid absorbing material.

Note that when the leading edge of the medium is positioned between the second support section 64 and the third support section 65, the magenta ink is ejected from the nozzles Nb61 to Nb120 illustrated in FIG. 10, and thus, borderless printing is performed on the leading edge of the medium and both side edges of the medium with the magenta ink. When the leading edge of the medium is positioned between the third support section 65 and the fourth support section 66, the yellow ink is ejected from the nozzles Nb1 to Nb60 illustrated in FIG. 10, and thus, borderless printing is performed on the leading edge of the medium and both side edges of the medium with the yellow ink. Note that, similarly, in a case where borderless printing is performed on the trailing edge of the medium, when the trailing edge of the medium is positioned between the first support section 63 and the second support section 64, borderless printing is performed on the trailing edge and both side edges of the medium with the cyan ink. When the trailing edge of the medium is positioned between the second support section 64 and the third support section 65, borderless printing is performed on the trailing edge and both side edges of the medium with the magenta ink. When the trailing edge of the medium is positioned between the third support section 65 and the fourth support section 66, borderless printing is performed on the trailing edge and both side edges of the medium with the yellow ink.

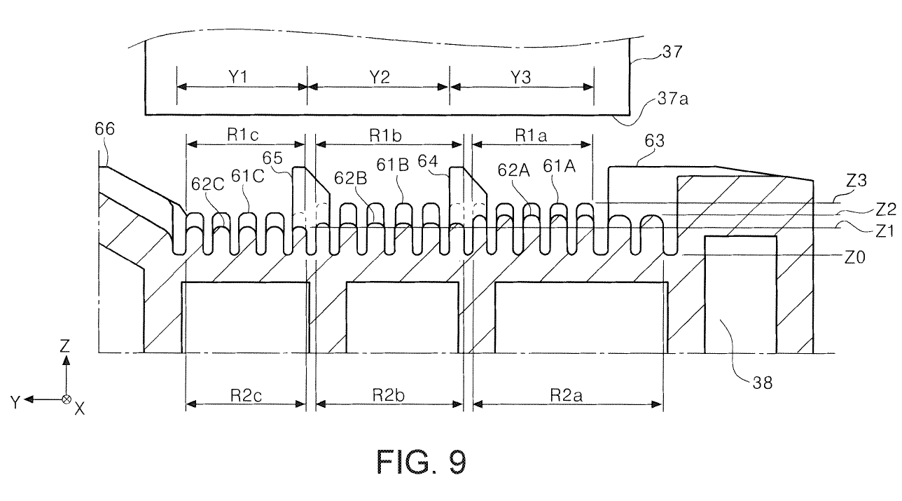

The first rib 61 is provided in the first region A1, and the second rib 62 is provided in the second region A2. These ribs will be described in more detail below. In FIG. 7, FIG. 8A, and FIG. 9, the first rib 61 is constituted by a first upstream rib 61A, a first midstream rib 61B, and a first downstream rib 61C. The first upstream rib 61A is the rib amongst the first ribs 61 that is positioned furthest upstream in the transport path 20. The first midstream rib 61B is a rib positioned downstream of the first upstream rib 61A in the transport path 20. The first downstream rib 61C is a rib positioned downstream of the first midstream rib 61B in the transport path 20. The second rib 62 is constituted by a second upstream rib 62A, a second midstream rib 62B, and a second downstream rib 62C. The second upstream rib 62A is a rib of the second rib 62 that is positioned most upstream in the transport path 20. The second midstream rib 62B is a rib positioned downstream of the second upstream rib 62A in the transport path 20. The second downstream rib 62C is a rib positioned downstream of the second midstream rib 62B in the transport path 20.

Here, as the leading edge of the medium is separated from the transport roller pair 26 to the downstream side of the transport path 20, the influence of the restraint by the transport roller pair 26 is reduced, and the leading edge of the medium is likely to hang downward. Therefore, there is a concern that the leading edge of the medium will contact the rib and the medium will be contaminated, or there is a concern that the leading edge of the medium will be caught by the rib and a jam occurs. The amount of ink absorbed by the trailing edge of the medium increases as transport progresses, and the trailing edge of the medium is likely to hang downward. Therefore, there is a concern that the leading edge of the medium will contact the rib and the medium will be contaminated. As described above, it is desirable that the height of the rib that, among the plurality of ribs, is positioned downstream of the transport path 20 is as low as possible in order to avoid contact with the leading edge or the trailing edge of the medium. However, when the height of the rib is uniformly reduced, the gap between the recording head 37 and the rib increases, and thus, mist is likely to be generated.

In view of the above, the first rib 61 and the second rib 62 in the present embodiment are configured as follows. First, regarding the first rib 61, the height of the first upstream rib 61A is equal to or higher than the height of the first midstream rib 61B, and is higher than the height of the first downstream rib 61C. Also, regarding the second rib 62, the height of the second upstream rib 62A is equal to or higher than the height of the second midstream rib 62B, and is higher than the height of the second downstream rib 62C. By this, it is possible to suppress the generation of mist while suppressing contact of the leading edge or the trailing edge of the medium with the rib downstream of the first upstream rib 61A or the rib downstream of the second upstream rib 62A. One of the causes of the generation of mist is that the gap between the first upstream rib 61A and the recording head 37 is wide. One of the causes of the generation of mist is that the gap between the second upstream rib 62A and the recording head 37 is wide.

Note that in the present embodiment, the height of the second upstream rib 62A is higher than the height of the second midstream rib 62B, and the height of the second midstream rib 62B is higher than the height of the second downstream rib 62C. By this, it is possible to suppress the generation of mist due to the increase in the gap between the second upstream rib 62A and the recording head 37 while suppressing contact of the leading edge or the trailing edge of the medium with the second midstream rib 62B or the second downstream rib 62C.

In the present embodiment, since the height of the first upstream rib 61A and the height of the first midstream rib 61B are aligned, it is possible to suppress the generation of mist while suppressing contact of the leading edge or the trailing edge of the medium with the first downstream rib 61C. One of the causes of the generation of mist is that the gap between the first upstream rib 61A and the recording head 37 is wide. One of the causes of the generation of mist is that the gap between the first midstream rib 61B and the recording head 37 is wide.

Since the medium curls up by absorbing ink, the edge portion in the width direction is likely to hang downward. According to the present aspect, the height of the second upstream rib 62A provided in the second regions A2, which are positioned on both sides of the first region A1 in the width direction, is equal to or less than the height of the first downstream rib 61C. Therefore, it is possible to suppress contact of the both edge portions of the medium in the width direction with the second rib 62 provided in the second region A2. Note that in the present embodiment, the height of the second upstream rib 62A is lower than the height of the first downstream rib 61C, but the height of the second upstream rib 62A and the height of the first downstream rib 61C may be aligned.

Note that in FIG. 9, the height position indicated by reference symbol Z3, that is, the position in the Z-axis direction, is the height position of the top portion of the first upstream rib 61A. The height position indicated by reference symbol Z2 is the height position of the top portion of the second upstream rib 62A. The height position indicated by reference symbol Z1 is the height position of the top portion of the second downstream rib 62C. The height indicated by reference symbol Z0 is the height direction position of the base end section of the first rib 61 and the base end section of the second rib 62. In the present embodiment, the height of the first downstream rib 61C is slightly higher than the height position Z2, that is, the height position of the second upstream rib 62A.

Note that the above configuration can be rephrased as follows. The liquid receiving section 60 includes an upstream liquid receiving region as a region for receiving liquid, and a downstream liquid receiving region positioned downstream of the upstream liquid receiving region in the transport path 20. For example, assuming that the first region A1 is the liquid receiving section and the region where the first upstream rib 61A is disposed is the upstream liquid receiving region, and the region where the first downstream rib 61C is disposed can be assumed to be the downstream liquid receiving region. Assuming that when the first upstream rib 61A is an upstream rib and the first downstream rib 61C is a downstream rib, the height of the upstream rib is higher than the height of the downstream rib. According to such a configuration, it is possible to suppress the generation of mist due to the increase in the gap between the upstream rib and the recording head 37 while suppressing contact of the leading edge or the trailing edge of the medium with the downstream rib. As described above, the upstream liquid receiving region and the downstream liquid receiving region and the upstream rib and the downstream rib are in a relative relationship, and it is not limited to the relationship between the first upstream rib 61A and the first downstream rib 61C described above as an example. The relationship between the upstream liquid receiving region and the downstream liquid receiving region and the relationship between the upstream rib and the downstream rib can be applied to a relationship between any two ribs of the first upstream rib 61A, the first midstream rib 61B, and the first downstream rib 61C. Similarly, assuming that the second region A2 is the liquid receiving section, and the relationship between the upstream rib and the downstream rib described above can be applied to the relationship between any two ribs among the second upstream rib 62A, the second midstream rib 62B, and the second downstream rib 62C.

Note that in the present embodiment, the height of the first upstream rib 61A and the height of the first midstream rib 61B are aligned, but the height of the first upstream rib 61A may be higher than the height of the first midstream rib 61B. In the present embodiment, the height of the first midstream rib 61B is higher than the height of the first downstream rib 61C, but the height of the first midstream rib 61B and the height of the first downstream rib 61C may be aligned. Alternatively, the height of the first midstream rib 61B may be higher than the height of the first downstream rib 61C. Alternatively, the height of the first midstream rib 61B may be lower than the height of the first downstream rib 61C.

In the present embodiment, the height of the second upstream rib 62A is higher than the height of the second midstream rib 62B, but the height of the second upstream rib 62A and the height of the second midstream rib 62B may be aligned. In the present embodiment, the height of the second midstream rib 62B is higher than the height of the second downstream rib 62C, but the height of the second midstream rib 62B and the height of the second downstream rib 62C may be aligned. Alternatively, the height of the second midstream rib 62B may be lower than the height of the second downstream rib 62C.

In the present embodiment, the support member 38 includes the first support section 63, the second support section 64, the third support section 65, and the fourth support section 66 as portions that support the medium. The second support section 64 and the third support section 65 are positioned in the first region A1. At least a part of the plurality of first upstream ribs 61A is positioned between the first support section 63 and the second support section 64 in the transport path 20. At least a part of the plurality of first midstream ribs 61B is positioned between the second support section 64 and the third support section 65 in the transport path 20. At least a part of the plurality of first downstream ribs 61C is positioned between the third support section 65 and the fourth support section 66 in the transport path 20. The first upstream rib 61A or the first midstream rib 61B is disposed between two second support sections 64 that are adjacent to each other in the width direction. The first midstream rib 61B or the first downstream rib 61C is disposed between two third support sections 65 that are adjacent to each other in the width direction.

According to the above configuration, the medium can be supported in the first region A1 by the second support section 64 and the third support section 65, and the medium can be suppressed from hanging down. At least one first upstream rib 61A or one first midstream rib 61B is disposed between two second support sections 64 that are adjacent to each other in the width direction. Therefore, ink can be received between the two second support sections 64 adjacent to each other. At least one first midstream rib 61B or one first downstream rib 61C is disposed between two third support sections 65 that are adjacent to each other in the width direction. Therefore, ink can be received between two third support sections 65 that are adjacent to each other.

Note that in the present embodiment, a part of the first upstream rib 61A and a part of the first midstream rib 61B are disposed between two second support sections 64 that are adjacent to each other in the width direction. In FIG. 9, reference symbol R1a indicates a placement region of the first upstream rib 61A in the transport direction, and reference symbol R1b indicates a placement region of the first midstream rib 61B in the transport direction. In the present embodiment, a part of the first midstream rib 61B and a part of the first downstream rib 61C are disposed between two third support sections 65 adjacent to each other in the width direction. In FIG. 9, reference symbol R1c indicates a placement region of the first downstream rib 61C in the transport direction. Note that in FIG. 9, reference symbol R2a indicates a placement region of the second upstream rib 62A in the transport direction. Reference symbol R2b indicates a placement region of the second midstream rib 62B in the transport direction. Reference symbol R2c indicates a placement region of the second downstream rib 62C in the transport direction.

Hereinafter, the features of the present embodiment will be further described. In the present embodiment, the length of the first rib 61 in the width direction is longer than the length of the second rib 62. However, the first rib 61 provided between two second support sections 64 that are adjacent to each other in the width direction and between two third support sections 65 that are adjacent to each other in the width direction are excluded.

In the present embodiment, as illustrated by position Z0 in FIG. 9, the height positions of the base end section of the first rib 61 and the base end section of the second rib 62 are aligned. That is, the height positions of the bottom portion of the groove formed between the two adjacent first ribs 61 and the bottom portion of the groove formed between the two adjacent second ribs 62 are aligned. By this, the size of the support member 38 in the height direction can be reduced as compared with a configuration in which the height positions of the base end sections of the first rib 61 and the base end sections of the second rib 62 are not aligned.

In the present embodiment, at least a part of the nozzles Nb121 to Nb180 (see FIG. 10) that eject cyan ink can face the first upstream rib 61A and the second upstream rib 62A. At least a part of the nozzles Nb61 to Nb120 (see FIG. 10) that eject magenta ink can face the first midstream rib 61B and the second midstream rib 62B. At least a part of the nozzles Nb1 to Nb60 (see FIG. 10) that eject yellow ink can face the first downstream rib 61C and the second downstream rib 62C. As described above, the region Y3 illustrated in FIG. 9 is a placement region of the nozzles Nb121 to Nb180 that eject cyan ink. The region Y2 is a placement region of the nozzles Nb61 to Nb120 that eject magenta ink. The region Y1 is a placement region of the nozzles Nb1 to Nb60 that eject yellow ink.

The darker the color of the ink, the more noticeable the mist when it is generated and adheres, and therefore, in the present embodiment, the nozzles that eject ink the darker color face the rib having a higher height as described above. By this, when the cyan ink, which is the darkest color, is ejected, the generation of mist can be suppressed, and the portion to which the mist adheres can be made inconspicuous. The same applies to the case of ejecting magenta ink, and it is possible to suppress the generation of mist compared to yellow, and the portion to which the mist adheres can be made less conspicuous.

Note that in the present embodiment, as illustrated in FIG. 9, some of the nozzles Nb121 to Nb180 that eject cyan ink can face the first upstream rib 61A and the second upstream rib 62A. However, all of the nozzles Nb121 to Nb180 may be able to face the first upstream rib 61A or the second upstream rib 62A. In the present embodiment, some of the nozzles Nb61 to Nb120 that eject magenta ink can face the first midstream rib 61B and the second midstream rib 62B. However, all of the nozzles Nb61 to Nb120 may be able to face the first midstream rib 61B or the second midstream rib 62B. In the present embodiment, some of the nozzles Nb1 to Nb60 that eject yellow ink can face the first downstream rib 61C and the second downstream rib 62C. However, all of the nozzles Nb1 to Nb60 may be able to face the first downstream rib 61C or the second downstream rib 62C.

The present disclosure is not limited to the embodiments and modifications described above, various modifications are possible within the scope of the disclosure described in the claims, it is needless to say that they are also included in the scope of the present disclosure.

What is claimed is:

1. A recording device comprising:
a liquid ejection head configured to, in a transport path that transports the medium, perform recording by ejecting liquid onto a medium;
a support section configured to, at a position facing the liquid ejection head, support the medium;
a liquid receiving section that is a portion provided in the support section and that is configured to receive liquid ejected from the liquid ejection head; and
a transport section that is positioned upstream of the support section in the transport path and that is configured to transport the medium, wherein
the liquid receiving section is provided with a plurality of ribs extending along a width direction, which is a direction intersecting a medium transport direction, at intervals along the medium transport direction,
the liquid receiving section includes, as a region for receiving liquid, a first region and a second region, which are positioned on both sides with respect to the first region in the width direction,
the second region is a region that receives liquid ejected at a position deviated from an end portion of the medium in the width direction,
assuming that a plurality of ribs provided in the first region are first ribs and a plurality of ribs provided in the second region are second ribs,
assuming that among the plurality of first ribs, a rib that is positioned most upstream in the transport path is a first upstream rib, a rib that is positioned downstream of the first upstream rib in the transport path is a first midstream rib, and a rib that is positioned downstream of the first midstream rib in the transport path is a first downstream rib,
assuming that among the plurality of second ribs, a rib that is positioned most upstream in the transport path is a second upstream rib, a rib that is positioned downstream of the second upstream rib in the transport path is a second midstream rib, and a rib that is positioned downstream of the second midstream rib in the transport path is a second downstream rib,
a height of the first upstream rib is equal to or higher than a height of the first midstream rib and higher than a height of the first downstream rib, and
a height of the second upstream rib is equal to or higher than a height of the second midstream rib and higher than a height of the second downstream rib.

2. The recording device according to claim 1, wherein
the height of the second upstream rib is higher than the height of the second midstream rib and
the height of the second midstream rib is higher than the height of the second downstream rib.

3. The recording device according to claim 1, wherein
the height of the first upstream rib and the height of the first midstream rib are aligned.

4. The recording device according to claim 1, wherein
the height of the second upstream rib is equal to or less than the height of the first downstream rib.

5. The recording device according to claim 1, wherein
the support section has, as portions that support medium,
a plurality of first support sections disposed at intervals along the width direction,
a plurality of second support sections that are positioned downstream of the first support sections in the transport path and that are disposed at intervals along the width direction,
a plurality of third support sections that are positioned downstream of the second support sections in the transport path and that are disposed at intervals along the width direction, and
a plurality of fourth support sections that are positioned downstream of the third support sections in the transport path and that are disposed at intervals along the width direction,
the second support sections and the third support sections are positioned in the first region,
at least some of a plurality of the first upstream ribs are positioned between the first support sections and the second support sections in the transport path,
at least some of a plurality of the first midstream ribs are positioned between the second support sections and the third support sections in the transport path,
at least some of a plurality of the first downstream ribs are positioned between the third support sections and the fourth support sections in the transport path,
at least one first upstream rib or one first midstream rib is disposed between two second support sections that are adjacent to each other in the width direction, and
at least one first midstream rib or one first downstream rib is disposed between two third support sections that are adjacent to each other in the width direction.

6. The recording device according to claim 1, wherein
a length of the first rib in the width direction is longer than a length of the second rib.

7. The recording device according to claim 1, wherein
a height position of the base end section of the first rib and the base end section of the second rib are aligned.

8. The recording device according to claim 1, wherein
the liquid ejection head has a plurality of nozzles configured to eject liquid,
the plurality of nozzles include,
a first nozzle configured to eject a liquid of a first color,
a second nozzle is a nozzle that is configured to eject a liquid of a second color, which is darker than the first color, and that is positioned upstream of the first nozzle in the transport path, and
a third nozzle is a nozzle that is configured to eject a liquid of a third color, which is darker than the second color, and that is positioned upstream of the second nozzle in the transport path,
at least some of the plurality of third nozzles are configured to face the first upstream rib and the second upstream rib,
at least some of the plurality of second nozzles are configured to face the first midstream rib and the second midstream rib, and
at least some of the plurality of first nozzles are configured to face the first downstream rib and the second downstream rib.

9. The recording device according to claim 8, wherein
the third color is cyan,
the second color is magenta, and
the first color is yellow.

10. A recording device comprising:
a liquid ejection head configured to, in a transport path that transports the medium, perform recording by ejecting liquid onto a medium;
a support section configured to, at a position facing the liquid ejection head, support the medium;
a liquid receiving section that is a portion provided in the support section and that is configured to receive liquid ejected from the liquid ejection head; and
a transport section that is positioned upstream of the support section in the transport path and that is configured to transport the medium, wherein
the liquid receiving section is provided with a plurality of ribs extending along a width direction, which is a direction intersecting a medium transport direction, at intervals along the medium transport direction,
the liquid receiving section includes, as regions for receiving liquid, an upstream liquid receiving region and a downstream liquid receiving region, which is positioned in the transport path downstream with respect to the upstream liquid receiving region, and
assuming that the rib provided in the upstream liquid receiving region is an upstream rib and the rib provided in the downstream liquid receiving region is a downstream rib, a height of the upstream rib is higher than a height of the downstream rib.

11. The recording device according to claim 10, wherein
the liquid receiving section receives the liquid at a position inside both end portions of the medium in the width direction.

12. The recording device according to claim 10, wherein
the liquid receiving section receives the liquid at a position outside both end portions of the medium in the width direction.
